(19) United States
(12) Patent Application Publication
(10) Pub. No.: US 2010/0064013 A1
(43) Pub. Date: Mar. 11, 2010

(54) E-Mail Monitoring System

(75) Inventor: Philip John Aranzulla, Newcastle Upon Tyne (GB)

Correspondence Address: PATENT DOCKET ADMINISTRATOR;LOWENSTEIN SANDLER PC, 65 LIVINGSTON AVENUE, ROSELAND, NJ, 07068, US

(73) Assignee: UPTIME365 LIMITED, Newcastle Upon Tyne (GB)

(21) Appl. No.: 12/282,133

(22) PCT Filed: Mar. 8, 2007
(86) PCT No.: PCT/GB2007/000804

§ 371 Date: Jan. 15, 2009

(30) Foreign Application Priority Data
Mar. 9, 2006 (GB) 0604786.4

(51) Int. Cl. G06F 15/16; G06F 15/177; G06F 15/173

(52) U.S. Cl. 709/206; 709/221; 709/239

(57) ABSTRACT

A monitoring system is described which monitors the effect of down time of an e-mail server (2) to the disruption of communication between a client computer (1) and a remote computer (7). The monitoring is achieved through the presence of a monitor program (22) which detects that an e-mail server (2) is not functioning properly and then causes messages to be re-routed via a backup e-mail system (3-1 . . . 3-n). The backup e-mail system (3-1 . . . 3-n) sends statistics indicating the volume of e-mail received to a central monitoring system (8) which enables data indicative of the extent to which failure of the e-mail server (2) effects communication of the client computer (1) to be identified.

The present application concerns an e-mail monitoring system. More specifically the present application concerns method and apparatus for monitoring the extent to which the down time of an e-mail server is disruptive to the flow of e-mail between a client computer and remote computers.

Whilst large organisations will often maintain a dedicated e-mail server, smaller organisations generally connect to the Internet via a separate Internet service provider or ISP. In such circumstance when an e-mail message is to be despatched, the message is often routed via the ISP's outgoing e-mail server prior to being routed via the Internet to its destination. In other cases where the smaller organisation uses a separate hosting provider, outgoing e-mails may be routed via the hosting organisation's outgoing e-mail server.

Similarly when a remote computer sends an e-mail to the client computer, the incoming e-mail is routed by routers present in the Internet so as to arrive at an ISP's (or hosting organisation's) incoming e-mail server. In general, a separate e-mail box corresponding to each e-mail address supported by the ISP's (or hosting organisation's) mail server is then maintained at the incoming e-mail server where an incoming message is stored. When a client computer accesses their e-mail, the messages present at the ISP's (or hosting organisation's) incoming e-mail server are transferred from the ISP's (or hosting organisation's) incoming e-mail server to the client computer where they can be read. This could mean copying the e-mails in the transfer so retaining a copy on the server or moving them and deleting them from the server during transfer.

As small businesses become increasingly reliant upon e-mail communications, it is increasingly important for such messages not to be disrupted. Occasionally, however, errors or updates of an ISP's (or hosting organisation's) e-mail computers necessitate taking such servers off line. This can cause significant disruption as whilst the e-mail server is off line a client computer can neither send nor receive e-mail messages.

Furthermore when remote computers attempt to send an e-mail message to the client computer, an error message may be returned informing the sender that the message could not be delivered. This may give the erroneous impression that a client's contact details are incorrect or alternatively that the client no longer exists.

In order to avoid the problems with an e-mail server going off line, routine maintenance of e-mail servers is normally scheduled by an ISP (or hosting organisation) to be at a time when the e-mail server is most likely to be dealing with a low level of traffic. Although such scheduling minimises the disruption caused, periods of low traffic overall may not necessarily correspond to periods of low traffic for a specific client. This might be the case for example if a client often receives e-mails from international contacts.

It would therefore be useful for a client computer to be able to determine the extent to which an ISP's e-mail server is off line and more particularly the extent to which such periods are disruptive to the flow of messages between their computers and remote computers.

In accordance with one aspect of the present invention there is provided an e-mail monitoring system comprising: a client computer; an e-mail server; a backup server; and a communications network operable to transmit data between said client computer, said e-mail server and said backup server, wherein a monitor program is provided at said client computer which is operable to determine whether said client computer can dispatch and/or receive e-mail messages via said e-mail server and is responsive to determining that said client computer is unable to send and/or receive e-mail messages via said e-mail server to configure said client computer to send and receive messages via said backup server until the functionality of said e-mail server is restored, said backup server being configured to monitor the volume of messages re-routed via said back up server to determine the extent of disruption of communication caused by said client computer being unable to dispatch and/or receive e-mail messages via said e-mail server.

An embodiment of the present invention will now be described in detail with reference to the accompanying drawings in which:

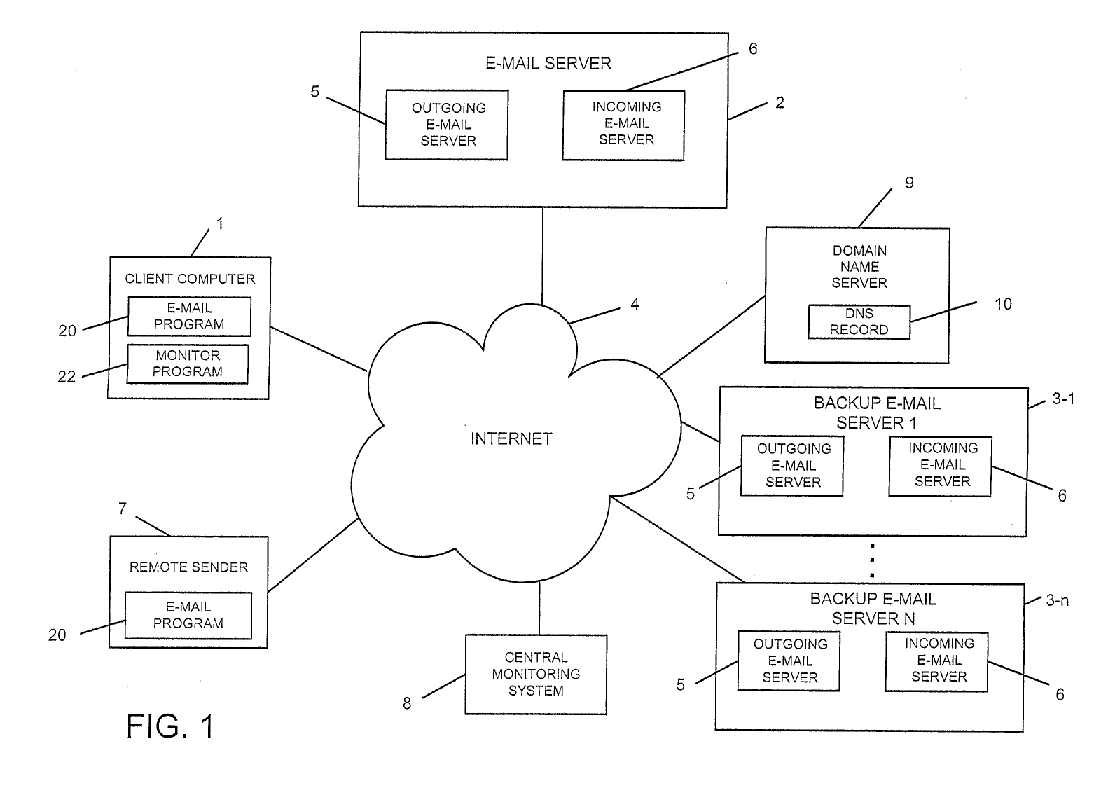

FIG. 1 is a schematic block diagram of a communications network incorporating a monitoring system in accordance with an embodiment of the present invention; and

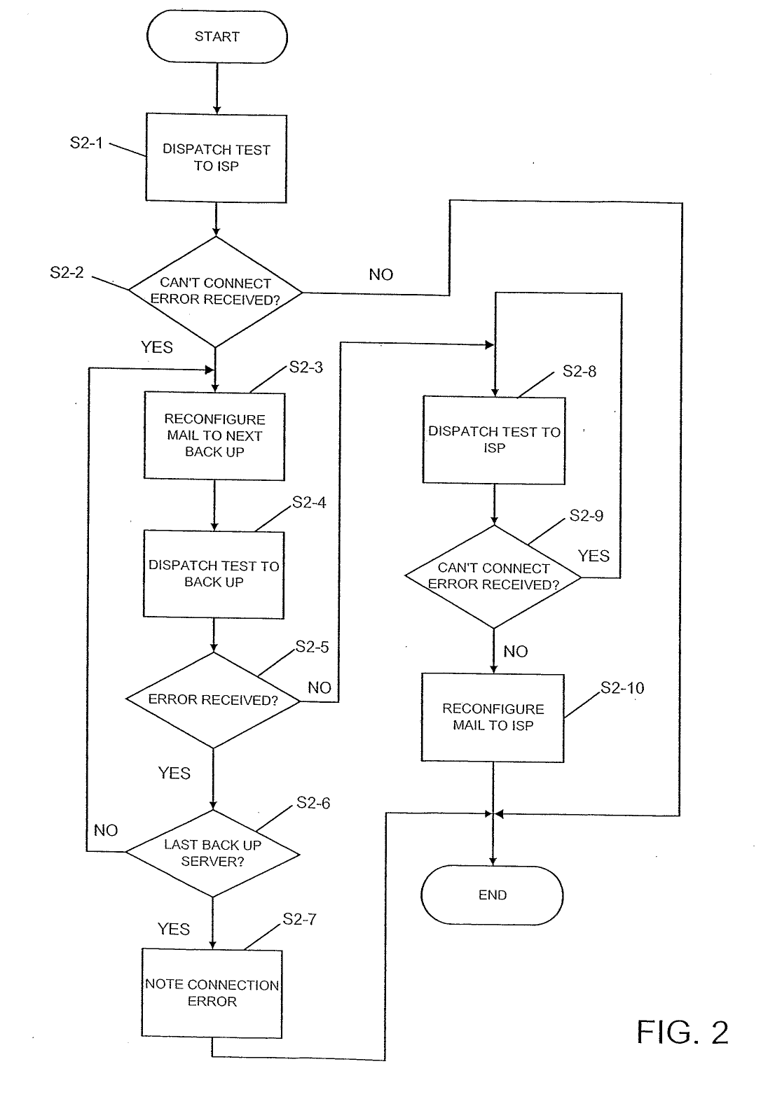

FIG. 2 is a flow diagram of the processing of a monitoring program of a client computer of the communications network of FIG. 1.

Referring to FIG. 1, a computer network is shown comprising a client computer 1, an e-mail server 2 and a number of backup e-mail servers 3-1 . . . 3-n of which two are illustrated in FIG. 1. The client computer 1, e-mail server 2 and backup e-mail servers 3-1 . . . 3-n are all interconnected via the Internet 4.

Typically as is illustrated in FIG. 1 each e-mail server 2 and back up e-mail server 3-1 . . . 3-n will comprise two parts, an incoming e-mail server 6 for handling incoming messages and an outgoing e-mail server 5 for handling outgoing messages. These e-mail servers 5, 6 may either be incorporated within a single machine or alternatively may be separate physical machines.

Also connected to the Internet 4 are a remote sender computer 7, a central monitoring system 8 and a domain name server 9 storing a DNS record 10 for enabling messages to be appropriately routed to the e-mail server 2 and backup e-mail servers 3, 3-1 . . . 3-n.

Stored within the memories of the client computer 1 and the remote sender computer 7 are a conventional e-mail program such as Microsoft Outlook®. A monitor program 22 is also stored within the memory of the client computer 1.

As will be described in detail later, in this embodiment the monitoring program 22 and DNS record 10 are arranged so that in the event any portion of the e-mail server 2 ceases to function properly, for example because the e-mail server 2 is taken off line, the monitoring program 22 causes outgoing e-mail messages to be routed via one of the backup e-mail servers 3-1 . . . 3-n and the DNS record 10 interacting with the remote sender's computer 7 e-mail program 20 causes the same effect for incoming e-mails. The monitor program 22 then continues to monitor the functionality of the e-mail server 2 and when the e-mail server 2 is restored to normal service, the monitor program 22 and DNS record 10 cause messages to be routed once again via the e-mail server 2 rather than via one of the backup e-mail servers 3-1 . . . 3-n.

By arranging the backup e-mail servers 3-1 . . . 3-n to receive messages only when the normal e-mail server 2 is not functioning properly, the receipt of any message by the backup e-mail servers 3-1 . . . 3-n indicates both that a message either to or from the client computer 1 is in existence and that the routing of the message has been affected by a failure of functionality of the e-mail server 2. The volume of e-mail traffic for a particular client computer 1 is therefore indicative of the extent to which failure of the e-mail server 2 affects communication with the client computer 1.

In this embodiment each of the backup e-mail servers 3-1; . . . ; 3-n is arranged to report the receipt of e-mail traffic to the central monitoring system 8. The central monitoring system 8 then utilises the received reports to identify the extent to which communication with a particular client has been disrupted. In this way the central monitoring system 8 can help a user of a client computer 1 identify whether the maintenance or breakdown of an e-mail server 2 maintained by a particular ISP or hosting organisation is disruptive to the flow of communication to that particular client. At the same time, the routing of e-mail messages via the backup e-mail servers 3-1 . . . 3-n ensures that availability of e-mail services to the client computer is maintained at all times.

i) Routing of External Messages

Prior to describing the processing undertaken by the monitor program 22, the routing of an e-mail message from a remote sender computer 7 to a client computer 1 utilising the DNS record 10 will first be explained.

When an e-mail message is generated by an e-mail program 20, the e-mail message is required to have a destination e-mail address. Such a destination e-mail address is composed of a mailbox name or forwarding alias separated from a domain name by an @ symbol. Thus for example a typical e-mail address would be philip_aranzulla@zullatec.com, where philip_aranzulla is the mailbox name and zullatec.com is the domain name.

When a message is to be dispatched via the Internet 4, an outgoing e-mail server 5 dispatching an e-mail connects to a local domain name server 9 for translation of the domain name portion of a destination address into a mail exchange name. This is the name for the incoming e-mail server 6 hosting the destination mailbox for that e-mail's destination address domain name. This e-mail server 6 name can then be translated into the server's IP address via a further query for the mail exchange name's address record.

If the local DNS server 9 can not translate the domain name into the mail exchange name or the corresponding IP address which will be case if it does not hold records for both the e-mail destination domain name and the corresponding mail exchange domain name, the DNS server 9 will contact other DNS servers further up the domain name hierarchy until the domain name is resolved. When the domain name is resolved first to its associated mail exchange server name and then to the mail exchange server's IP address, this IP address in the form of four numbers separated by stops is then utilised by routers present within the Internet to determine the appropriate computer destination for the e-mail message.

Conventionally a DNS record 10 associates a single destination e-mail domain name with a single IP address. Thus for example in the case of the IP address for zullatec.com a typical DNS mail exchange record would be in the following form:

| DOMAIN NAME | MAIL EXCHANGE NAME | PRIORITY NO. |
|---|---|---|
| zullatec.com | AAA | 1 |

where AAA is a unique domain name assigned to the server arranged to receive incoming e-mail for the domain name zullatec.com.

This mail exchange domain name is translated to an IP address by obtaining the DNS address record for the AAA domain name, this record being in the following form:

| DOMAIN NAME | IP ADDRESS |
|---|---|
| AAA | xxx.xxx.xxx.xxx |

where xxx.xxx.xxx.xxx is a unique number assignees to the server arranged to receive incoming e-mail for the domain name zullatec.com.

Therefore there are two DNS records 10 which may or may not be found at the same domain name server 9. These two records hold the information which allows an e-mail to be routed to a destination mailbox at an incoming e-mail server. The DNS record for the client computer 1 e-mail address domain name holds the domain name of the incoming e-mail server 6 of the e-mail server 2, and the DNS record for the incoming e-mail server 6 of the e-mail server 2 domain name holds the unique IP address for the incoming e-mail server which holds the client computer 1 mailbox.

In contrast to the normal conventional mail exchange DNS record, in this embodiment the DNS record 10 relating to the client computer 1 domain name is modified to associate the domain name with multiple mail exchange names, where each mail exchange name has an associated priority number and where the mail exchange names correspond to the mail exchange name for firstly the incoming e-mail server 6 addressed for the e-mail server 2 and then the mail exchange name for the successive backup server e-mail servers 3-1 . . . 3-n.

Thus for example assuming that the mail for the domain name zullatec.com is hosted by the e-mail server 2, the mail exchange information in the DNS record entry zullatec.com would be in the following form:

| DOMAIN NAME | MAIL EXCHANGE NAME | PRIORITY NO. |
|---|---|---|
| zullatec.com | AAA | 1 |
| | BBB | 2 |
| | CCC | 3 |
| | | Etc |

where AAA is the mail exchange name assigned to the incoming e-mail server 6 of the main server 2 and BBB, CCC, etc are the mail exchange names assigned to the incoming e-mail servers 6 of the backup servers 3-1 . . . 3-n.

It will be appreciated that some embodiments could use a list of prioritised domain names, with each one potentially requiring username and password to access that mail account on the incoming e-mail server 6 unique to that backup e-mail server and so unique to that domain name so as to limit access to certain domains.

In use the association of a domain name with multiple mail exchange names causes the e-mail program 20 at remote sender 7 to initially attempt to route a message associated with a particular domain name to the IP address of the mail exchange name with the lowest priority number in the DNS record 10. If for any reason this does not prove possible the IP address of the mail exchange name with the next lowest priority number in the DNS record 10 will be attempted, and so on.

Thus by modifying the DNS record 10 in this way for all external senders of e-mail messages, e-mail messages are progressively routed to different e-mail servers in the associated priority number order within the domain name record 10. Thus by providing a number of backup e-mail servers 3-1 . . . 3-n in the event of any particular servers going online, it can be virtually guaranteed that one of the servers will receive a message dispatched from a remote sender computer 7.

Furthermore, as the e-mail program 20 of the remote sender computer 7 combined with the routing system of the Internet 4 attempts to route messages on the basis of the entries in the DNS record 10 in the order in which they appear in the record, e-mail traffic intended for the e-mail server 2 will only be received by the backup e-mail servers 3-1 . . . 3-n in the event that the e-mail server 2 is unable to receive a message for any particular reason for example because the e-mail server 2 is off line. The receipt of any external e-mails by the backup e-mail servers 3-1 . . . 3-n is therefore indicative of both an error of some kind occurring at the e-mail server 2 and that the error is such to cause traffic from a remote sender 7 to be affected by the error at the e-mail server 2.

(ii) Routing of Messages Originating From Client Computer

In addition to modifying the DNS record 10 so that an externally originating e-mail is in the event of a failure of the main server 2 routed via the backup e-mail servers 3-1 . . . 3-n, in accordance with the claimed invention a monitor program 22 present on the client computer 1 causes the outgoing e-mail of the e-mail program 20 present in the memory of the client computer 1 to be routed in a similar manner as will now be explained.

Frequently an e-mail program 20 will download e-mail messages from an incoming e-mail server 6 in a similar way to which outgoing message are routed as has just been described. That is to say the e-mail program will store data identifying the domain name for an incoming e-mail server 6. When e-mail messages are to be retrieved from the e-mail server 6, this domain name data is converted into an IP address using a DNS record 10 as has previously been described. The obtained IP address is then used to route an access request via the internet 4 to the incoming e-mail server 6.

However, although ordinarily the routing of messages between a client computer 1 and a related e-mail server 2 is dependent upon accessing a DNS record, occasionally that may not be the case. Thus for example when a client computer wishes to download received e-mail messages, the e-mail program 20 of the client computer 1 may attempt to connect to the incoming e-mail server portion 6 using pre-stored copy of the IP address corresponding to the incoming e-mail server 6. In such circumstance no access to a DNS record 10 is required.

In such circumstance, when accessing an incoming e-mail server 6, an access request message is sent by the e-mail program 20 via the internet 4 to the incoming e-mail server 6 using the pre-stored IP address data. When the access request is received, the incoming e-mail server 6 then responds by dispatching copies of any previously received messages back via the Internet 4 to the client computer 1 using an IP address associated with that client computer 1.

The dispatch of a message by the e-mail program 20 of a client computer 1 occurs in a similar way. In this respect the e-mail program 20 stores data corresponding to the IP address for the outgoing e-mail server 5. When an e-mail message including destination address has been generated by the e-mail program 20, it is initially dispatched via the Internet utilising the IP address for the outgoing e-mail server S so as to cause the message to be routed to the outgoing e-mail server S. The outgoing e-mail server 5 then processes the destination address included in the message using the DNS system so as to convert the destination address to the destination mail exchange domain name and then obtain the IP address for the remote computer, then the message is routed via the Internet 4 using the obtained destination IP address for the e-mail domain.

Thus when IP addresses for both the outgoing server 5 and incoming server 6 of the e-mail server 2 are stored within the e-mail program 20 on a client computer 1, in the event that the outgoing e-mail server 5 or incoming e-mail server 6 cannot be contacted, an error message is generated by the e-mail program 20. The functioning of the monitor program 22 to avoid such a problem will now be described in detail with reference to FIG. 2 which is a flow diagram of the processing undertaken by the monitor program 22.

Processing of Monitor Program

Periodically, in order for the monitor program 22 to establish whether or not the e-mail server 2 is accessible, the monitor program 22 will dispatch a test (S2-1) to the e-mail server 2.

The test dispatched by the monitor program 22 may take a number of different forms. Thus for example in one embodiment the test undertaken by the monitor program 22 could be of the form of an access request or for example a login request being sent to either the outgoing e-mail server 5 or the incoming e-mail server 6.

Alternatively the monitor program 22 could attempt to send a test message to itself via the e-mail server 2. In this case the monitor program 22 would cause the e-mail program 20 to send a test message where the destination address corresponds to the destination address for the user's mailbox on the e-mail server 6. If this test message was successfully dispatched and then subsequently received, this would indicate that the incoming e-mail server 6 was accessible.

The monitor program 22 could then instruct the e-mail program 20 to attempt to download an e-mail message where if an e-mail message corresponding to the generated test message was received this would indicate that access to the outgoing e-mail server 5 was possible and transfer between the outgoing e-mail server 5 and the incoming e-mail server 6 was also working correctly. When the test message is received by the client computer 1 the monitor program 22 would then be arranged to intercept, process and delete the e-mail message to prevent a message being displayed to a user using the e-mail program 20.

As merely attempting to access either the incoming mail server 6 or the outgoing mail server 5 tests a slightly different functionality compared with sending and receiving a test message, if is preferable for the monitor program 22 to be arranged to perform both types of test.

Thus for example the monitor program 22 could be arranged to check the accessibility of the incoming e-mail server 6 and an outgoing e-mail server 5 with relatively high frequency say for example once every five minutes and attempting an extensive test by dispatching a test e-mail and retrieving the test e-mail with a lower frequency say once every 30 minutes.

Having dispatched a test out to the e-mail server, the monitor program 22 waits to determine (s2-2) whether an error signal is received.

In the case of a simple access test, this would be either a response from server 2 or a timeout within the monitor program instructing the client computer 1 that either the outgoing or incoming e-mail server 5, respectively were not accessible. In the case of sending and retrieving a test message, an error will be indicated by the failure of the e-mail program 20 to send and subsequently retrieve a test message sent via the e-mail server 2.

In this embodiment the monitor program 22 is arranged to intercept any error signals generated in response to test connection attempts to the e-mail server 2. If no error signal is received, this indicates to the monitor program 22 that the e-mail server is functioning correctly and no further action is taken until the next test is performed. In cases where the test e-mail is not subsequently received within a reasonable time period, the monitor program deduces that the e-mail server 2 is not functioning correctly.

In the event that the monitor program.22 intercepts an error message or has a timeout expiry waiting for a response from e-mail server 2 or deduces the e-mail server 2 is not functioning correctly due to the e-mail program 20 not having received the test message within a reasonable time, the monitor program 22 then

(S2-3) proceeds to reconfigure the e-mail program 20 so as to change the default IP address stored within the mail program 20 from the IP addresses for the outgoing or incoming e-mail servers 5, 6 of the main e-mail server 2 to IP addresses for the incoming and outgoing e-mail servers 5, 6 of the first backup e-mail server 3-1. Depending on the error type received, the monitor program 22 may just change either the incoming e-mail IP address details or the outgoing e-mail IP address details.

The monitor program 22 then (S2-4) proceeds to dispatch a further test message or access test to the outgoing e-mail server and incoming e-mail server 5, 6 of the backup e-mail server 3-1 now selected. If an error is received (S2-5) in response to this test, this will indicate to the monitor program that either the selected backup e-mail server 3-1 is itself off line, for example for routine maintenance, or alternatively the communication link between the client computer 1 and the Internet 4 is not functioning properly.

In this embodiment if an error is received by the monitor program 22 the monitor program 22 then (S2-6) proceeds to check whether the current IP addresses in use correspond to incoming and outgoing e-mail servers 5,6 of the final backup e-mail server 3-n. If this is not the case, the monitor program 22 then (S2-3) proceeds to reconfigure the mail program 20 to utilise the outgoing e-mail server and incoming e-mail server 5, 6 of the next backup e-mail server and test whether communication with that alternative backup e-mail server is working (S2-4-S2-5).

By providing a sufficiently large number of backup e-mail servers 3-1 . . . 3-n, it can be virtually guaranteed that allowing for routine maintenance of the servers 3-1 . . . 3-n and connection problems which may potentially occur for the backup e-mail servers 3-1 . . . 3-n, the presence of at least one backup e-mail server 3-1 . . . 3-n can be guaranteed. Thus in this embodiment where sufficient backup e-mail servers are provided, if the monitor program 22 determines (S2-6) that test connections have been sent out to all of the backup e-mail servers 3-1 . . . 3-n and every server has failed to respond properly to the test connections, this is taken to be indicative of there being a connection failure between the client computer 1 and the Internet 4. The monitor program 22 then proceeds to note the existence of the lack of a connection to the Internet and resets the mail program 20 to utilise the IP addresses of the usual outgoing e-mail server 5 and incoming e-mail server 6.

In the event that when the monitor program 22 dispatches a test, one of the backup e-mail servers 3-1 . . . 3-n, responds correctly, this indicates to the monitor program 22 that the client computer 1 is properly connected to the Internet 4. Since the connection between the client computer 1 and the backup e-mail server 3-1 . . . 3-n is working properly and the e-mail program 20 will at this stage be configured to utilise the selected backup e-mail server 3-1; . . . ; 3-n, despite communication with the main e-mail server 2 having failed, a user of the client computer 1 will still be able to dispatch e-mail messages.

Further since the action of the Internet 4 and the two DNS records 10 (one for obtaining the destination incoming e-mail server name, the other for obtaining that e-mail server's IP address) will be such as to route incoming messages from a remote sender 7 via the same selected server, a user of the client e-mail program 20 will also be able to receive e-mail messages. Thus whilst the e-mail server 2 is not functioning or is off line all traffic to or from the client computer 1 will pass through a functioning backup e-mail server.

After a working connection with one of the backup e-mail servers 3-1; . . . ; 3-n has been confirmed as operational, the monitor program 22 then proceeds to repeat (S2-8) the test of connectivity with the e-mail server 2 that the e-mail server had previously failed. If in response to the test a further error message is received (S2-9) the same test is repeated once again (S2-8) after a short delay. By repeatedly sending tests out to the non functioning e-mail server 2 the monitor program 22 checks to see whether the non-functioning e-mail server 2 has come back online.

When the e-mail server 2 begins working again, the monitor program 22 will stop receiving error messages (S2-9) in response to its tests of the functionality of the e-mail server 2. The monitor program 22 then reconfigures (s2-10) the e-mail program 20 to use the normal IP address data for the outgoing e-mail server and incoming e-mail server 6 of the main e-mail server 2 which will cause the e-mail program 20 to send and receive messages via the e-mail server 2 once more.

By having the monitor program 22 configure and reconfigure the default IP addresses used by the e-mail program 20 within the memory of the client computer 1, the monitor program 22 causes the messages sent by the e-mail program 20 to be re-routed in a similar way to the re-routing of messages generated by an external e-mail program 20 from a remote sender computer 7 are re-routed by the presence of multiple mail exchange names within the DNS record 10. At the same time whilst an e-mail server 2 is not functioning, the e-mail program 20 is also reconfigured so as to pick up mail messages from the next functioning backup e-mail server according to the associated priority in the DNS record 10.

It will be appreciated that although the periodic testing of the accessibility of the e-mail server 2 by the monitor program 22 and the subsequent reconfiguration of the e-mail program 20 will cause the e-mail program 20 to almost always access e-mail messages from the first functioning backup e-mail server 3-1; . . . ; 3-n to which external messages are being directed by the DNS record 10, there is a possibility that due to the delays in transmission times (and/or the periodicity of the test by the monitor program 22) occasionally an e-mail message from a remote sender 7 will be routed to a backup e-mail server 3-1; . . . ; 3-n other than the one which the e-mail program 20 is configured to access. In order to cover for such an eventuality, in this embodiment, the monitor program 22 is arranged to cause the e-mail program 20 to check all of the backup e-mail services 3-1 . . . 3-n for the presence of relevant messages on an occasional (i.e. less frequent) basis.

(iii) Collation of Disruption Statistics

As is explained above, the interaction of the monitor program 22 with the e-mail program 20 and the presence of multiple mail exchange names within the DNS record 10 cause all relevant messages to be re-routed to the backup e-mail servers 3-1 . . . 3-n when for any particular reason the e-mail server 2 is off line. The receipt of messages by these servers 3-1 . . . 3-n is therefore indicative of the presence of a problem with the e-mail server 2 which would in the absence of the backup system have disrupted communication with the client computer 1.

In this embodiment the backup e-mail servers 3-1 . . . 3-n are arranged to transmit data indicating the extent of traffic that they receive relating to a particular mailbox at the e-mail server 2 to a central monitoring system 8. When such data is received the central monitoring system 8 collates the data. The central monitoring system 8 when instructed to by the user using the monitor program 22 or on a periodic basis say for example weekly or monthly then generates an automatic report which is dispatched to the client computer 1 so that the user of a client computer 1 can be made aware of the amount of traffic that would have been disrupted had the backup system not been utilised.

By monitoring the e-mail traffic for a large number of client computers 1 and for e-mail services provided by a number of different ISP's (or hosting organisations) the extent to which failures or maintenance of different ISP's (or hosting organisations) servers disrupt the activities of particular clients can be generated and collated.

It will be appreciated that in addition to monitoring the volume of messages, the backup e-mail servers 3-1 . . . 3-n and central monitoring system 8 could also be arranged to monitor the timing of receipt of re-routed messages and thereby be in a position to provide to a user of a client computer 1 an indication of the time periods where maintenance of an ISP's e-mail server 2 is disruptive of communications to their client computer 1.

In the above described embodiment two types of e-mail system have been described, one where an e-mail program stores an IP address for an e-mail server 2 and one where an e-mail program utilises a domain name to access a server. In other embodiments, where an e-mail program 20 stores domain name data for accessing an e-mail server 2, a monitor program 22 could be arranged to store a set of prioritized domain names for use in the event that communication using a particular domain name failed. Such an embodiment would have the advantage of the e-mail program 20 on client computer 1 accessing a working e-mail server without the task of modifying the DNS record for e-mail server 2 (this often not being possible due to the DNS record contents being controlled by an external organisation).

In the main embodiment described above, the monitor program 22 determines which back up server 3-1; . . . ; 3-n is available for use (s2-3 . . . s2-5) and then monitors the main server 2 to see when the main server 2 comes back on-line. It will be appreciated that after a connection with at least one back-up server has been established, rather than merely monitoring the main server 2, the monitor program could also monitor the availability of the back-up servers 3-1 . . . 3-n as well.

The advantage of such an embodiment would be that if a connection to a back-up server were to fail, the system could detect such a failure and reroute messages via an alternative back up server after the failure had been detected.

In contrast to the main embodiment described above, in another embodiment, the DNS record 10 could be restricted so as to include only two entries with the one with the lowest priority number being assigned to incoming e-mail server 6 of the main server 2 and the higher priority number entry information being assigned to the incoming e-mail server 6 of one of the backup servers 3-1 . . . 3-n.

In situations when the specific incoming e-mail server 6 of backup e-mail server indicated in the DNS record with the higher priority number mail exchange information is offline, the mail exchange information with the higher priority number could then be assigned the incoming e-mail server 6 of the next backup server. This assignment could occur either by a system administrator manually altering the DNS record 10 information, or by automatically by providing a central monitoring system 11 which monitors the status of the backup e-mail servers 3-1 . . . 3-n and automatically changes the higher priority number mail exchange information of the DNS record 10 to an online backup e-mail server upon discovering that the backup e-mail server indicated by the higher priority number mail exchange information has gone off-line.

Thus for example the mail exchange information in a DNS record entry Zullatec.com in accordance with such an embodiment could be in the following form:

| DOMAIN NAME | MAIL EXCHANGE NAME | PRIORITY NO. |
|---|---|---|
| zullatec.com | AAA | 1 |
| | BBB | 2 |

When the system administrator or the central monitoring system changed the mail exchange information due to the incoming e-mail server 6 of the backup e-mail server BBB going offline, the mail exchange information of DNS record 10 could then be altered to become:

| DOMAIN NAME | MAIL EXCHANGE NAME | PRIORITY NO. |
|---|---|---|
| zullatec.com | AAA | 1 |
| | CCC | 2 |

Thus in cases where the incoming e-mail server 6 of the main e-mail server 2 is offline, e-mails are automatically routed by the routing system of the Internet 4 to the incoming e-mail server 6 of a different backup e-mail server without changing any information stored on the e-mail program 20 of the client computer 1 and 7, or the monitor program 22.

In another embodiment, instead of changing the mail exchange information of the higher priority number entry upon discovering that incoming e-mail server 6 of the backup e-mail server indicated by the mail exchange entry is down/offline, the address information corresponding to the higher priority number mail exchange name could be changed on DNS record 10 to an incoming e-mail server 6 on a different backup e-mail server.

Thus for example assuming that the mail exchange information in the DNS record entry Zullatec.com were to be in the following form:

| DOMAIN NAME | MAIL EXCHANGE NAME | PRIORITY NO. |
|---|---|---|
| zullatec.com | AAA | 1 |
| | BBB | 2 |

With the DNS address record for the BBB domain name is of the following form:

| DOMAIN NAME | IP ADDRESS |
|---|---|
| BBB | xxx.xxx.xxx.xxx |

When the system administrator or the central monitoring system 11 changes the address information it could become:

| DOMAIN NAME | IP ADDRESS |
|---|---|
| BBB | yyy.yyy.yyy.yyy |

Thus in cases where the incoming e-mail server 6 of the main e-mail server 2 is offline, e-mails are automatically routed by the routing system of the Internet 4 to the incoming e-mail server 6 of a different backup e-mail server without changing any information stored on the e-mail program 20 of the client computer 1 and 7, or the monitor program 22.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier can be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When a program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A computer network comprising:
a client computer;
an e-mail server;
a backup server; and
a communications network operable to transmit data between said client computer, said e-mail server and said backup server,
characterized in that a monitoring and reconfiguration module is provided at said client computer said monitoring and reconfiguration module being operable to determine whether said client computer can dispatch and/or receive e-mail messages via said e-mail server and is responsive to determining that said client computer is unable to send and/or receive e-mail messages via said e-mail server to configure said client computer to send and/or receive messages via said backup server until the functionality of said e-mail server is restored, said backup server being configured to monitor and record the volume of messages re-routed via said backup server to determine the extent of disruption of communication caused by said client computer being unable to dispatch and/or receive e-mail messages via said e-mail server.

2. A computer network in accordance with claim 1 wherein said monitoring and reconfiguration module is operable to determine whether said client computer can dispatch and/or receive e-mail messages via said e-mail server by causing a test message to be sent to and retrieved from said e-mail server and is responsive to determining that said client computer is unable to send and retrieve a test messages via said e-mail server to configure said client computer to send and receive messages via said backup server until the functionality of said e-mail server is restored.

3. A computer network in accordance with claim 1 wherein said monitoring and reconfiguration module is operable to determine whether said client computer can dispatch and/or receive e-mail messages via said e-mail server by sending an access request to said e-mail server and is responsive to receipt of an access failure error to configure said client computer to send and receive messages via said backup server until the functionality of said e-mail server is restored.

4. A computer network in accordance with claim 1 wherein said monitoring and reconfiguration module is operable to determine whether said client computer can dispatch and/or receive e-mail messages via said e-mail server by testing whether said client computer can dispatch and/or receive e-mail messages via said e-mail server on a periodic basis.

5. A computer network in accordance with claim 1 wherein said monitoring and reconfiguration module is responsive to determining that said client computer cannot dispatch and/or receive e-mail messages via said e-mail server to test on a periodic basis whether the functionality of said e-mail server has been restored and to re-configure said client computer to send and receive messages via said e-mail server when it is determined that the functionality of said e-mail server has been restored.

6. A computer network in accordance with claim 1, further comprising:
a remote sender computer; and
a domain name server storing domain name records, wherein said domain name record associates e-mail domain name data with host domain name data for said e-mail server and said backup server and wherein said remote sender computer is operable to route data to said e-mail server and said backup server utilising the destination host IP address the other domain name record stored by said domain name server.

7. A computer network in accordance with claim 6 wherein said remote sender computer is operable to attempt to route data to said e-mail server and is responsive to not being able to route data to said e-mail server to route data to said back-up server.

8. A computer network in accordance with claim 1, further comprising one or more further backup servers wherein said monitoring and reconfiguration module is responsive to determining that said client computer is unable to send and/or receive e-mail messages via said e-mail server to configure said client computer to send and/or receive messages via said a selected one of said backup servers and said one or more of said further backup servers until the functionality of said e-mail server is restored, said backup server and said one or more further backup servers being configured to monitor and record the volume of messages re-routed via said backup server and said one or more further backup servers to determine the extent of disruption of communication caused by said client computer being unable to dispatch and/or receive e-mail messages via said e-mail server.

9. A computer network in accordance with claim 8 wherein said monitoring and reconfiguration module is arranged to select one of said backup servers and said one or more of said further backup servers for routing messages to by successively testing whether said client computer can dispatch and/or receive e-mail messages via servers and configuring said client computer to send and/or receive messages via the first server determined to be operable to dispatch and/or receive e-mail messages until the functionality of said e-mail server is restored.

10. A computer network in accordance with claim 9 wherein said monitoring and reconfiguration module is responsive to determining that said client computer is unable to dispatch and/or receive e-mail messages via any of said further backup servers to record the existence of a connection error.

11. A computer network in accordance with claim 8 wherein said backup sever and said further backup servers are operable to collate data indicative of the volume of re-routed messages to determine the extent of disruption of communication caused by said client computer being unable to dispatch and/or receive e-mail messages via said e-mail server.

12. A computer network in accordance with claim 1 wherein said recordation of the volume of messages includes recording timing data relating to said re-routed messages.

13. A client computer comprising:
an e-mail module operable to send and receive messages; and
a monitoring and reconfiguration module operable to determine whether said client computer can dispatch and/or receive e-mail messages via a predefined e-mail server and responsive to determining that said client computer is unable to send and/or receive e-mail messages via said e-mail server to configure said e-mail module to send and/or receive messages via a backup server until the functionality of said e-mail server is restored.

14. A client computer in accordance with claim 13 wherein said monitoring and reconfiguration module is operable to determine whether said client computer can dispatch and/or receive e-mail messages via said e-mail server by causing a test message to be sent to and retrieved from said e-mail server and is responsive to determining that said client computer is unable to send and receive a test message via said e-mail to configure said e-mail module to send and receive messages via said backup server until the functionality of said e-mail server is restored.

15. A client computer in accordance with claim 13 wherein said monitoring and reconfiguration module is operable to determine whether said client computer can dispatch and/or receive e-mail messages via said e-mail server by sending an access request to said e-mail server and responsive to receipt of an access failure error to configure said e-mail module to send and receive messages via said backup server until the functionality of said e-mail server is restored.

16. A client computer in accordance with claim 13, wherein said monitoring and reconfiguration module is operable to determine whether said client computer can dispatch and/or receive e-mail messages via said e-mail server by testing whether said client computer can dispatch and/or receive e-mail messages via said e-mail server on a periodic basis.

17. A client computer in accordance with claim 13, wherein said monitoring and reconfiguration module is responsive to determining that said client computer cannot dispatch and/or receive e-mail messages via said e-mail server to test on a periodic basis whether the functionality of said e-mail server has been restored and to re-configure said e-mail module to send and receive messages via said e-mail server when it is determined that the functionality of said e-mail server has been restored.

18. A client computer in accordance with claim 13 wherein said monitoring and reconfiguration module is responsive to determining that said client computer is unable to send and/or receive e-mail messages via said e-mail server to configure said e-mail module to send and receive messages via said a selected one of said backup servers or one or more of further backup servers until the functionality of said e-mail server is restored.

19. A client computer in accordance with claim 18 wherein said monitoring and reconfiguration module is arranged to select one of said backup servers and said one or more of said further backup servers for routing messages to by successively testing whether said client computer can dispatch and/or receive e-mail messages via servers and configuring said e-mail module to send and receive messages via the first server determined to be operable to dispatch and/or receive e-mail messages until the functionality of said e-mail server is restored.

20. A client computer in accordance with claim 19 wherein said monitoring and reconfiguration module is responsive to determining that said client computer is unable to dispatch and/or receive e-mail messages via any of said further backup servers to record the existence of a connection error.

21. A storage medium storing computer interpretable instructions to cause a programmable computer having an e-mail module operable to send and receive messages to become configured as a client computer in accordance with any claim 13.

22. A storage medium in accordance with claim 21 comprising a computer disk.

23. A disk in accordance with claim 22 comprising a magnetic, magneto-optic or optical disk.

24. A storage medium in accordance with claim 21 comprising an electrical signal within a communications network.
